(19) United States
(12) Patent Application Publication
(10) Pub. No.: US 2024/0238712 A1
(43) Pub. Date: Jul. 18, 2024

(54) FILTER STRUCTURE

(71) Applicant: TOYO ALUMINIUM EKCO PRODUCTS CO., LTD., Osaka-shi, Osaka (JP)

(72) Inventor: Masashi ADACHI, Osaka-shi, Osaka (JP)

(73) Assignee: TOYO ALUMINIUM EKCO PRODUCTS CO., LTD., Osaka-shi, Osaka (JP)

(21) Appl. No.: 18/558,913

(22) PCT Filed: May 30, 2022
(86) PCT No.: PCT/JP2022/021850

§ 371 Date: Nov. 3, 2023

(30) Foreign Application Priority Data
May 31, 2021 (JP) 2021-090762

(51) Int. Cl. B01D 46/10; C09J 7/21; C09J 7/25; C09J 7/38; C09J 133/04; C09J 175/04

(52) U.S. Cl. CPC B01D 46/10; C09J 7/21; C09J 7/255; C09J 7/38; C09J 7/385; C09J 133/04; C09J 175/04; B01D 2265/04

(57) ABSTRACT

A filter structure (F) includes a filter layer (1), an adhesive layer (10), and a sheet layer (20). The sheet layer has a thickness of 12 μm to 75 μm, and has a surface roughness Ra of 0.09 μm to 0.4 μm on a surface in contact with the adhesive layer. By setting the thickness of the sheet layer to 12 μm or more, waving when the sheet layer is laminated on the adhesive layer is reduced, and surface smoothness of the adhesive layer is maintained. By setting the thickness of the sheet layer to 75 μm or less, the sheet layer is less likely to be separated from the adhesive layer during folding. Since the surface roughness Ra of the sheet layer is 0.4 μm or less, a surface roughness of the adhesive layer in contact with the sheet layer is controlled to a state of reliably exerting an adhesive force. Since the surface roughness of the sheet layer is 0.09 μm or more, handleability is improved, and a manufacturing cost is not increased.

### TECHNICAL FIELD

The present invention relates to a filter structure to adhere to an object such as a range hood, an air conditioner, an air cleaner, or an air vent to filter passing gas.

### BACKGROUND ART

In the related art, a filter structure mounted to a metal filter or a straightening plate of a range hood, an intake port of an air conditioner or an air cleaner, indoor and outdoor air vents or the like to filter passing air is used. For example, JP2002-85927A describes a filter structure mainly used for an air conditioner, and JP2017-15297A describes a filter structure used for a range hood with a straightening plate.

In general, the filter structures described in these literatures are each a structure including a sheet-shaped filter layer formed of a nonwoven fabric or the like, an adhesive layer formed on one surface of the filter layer by an adhesive, and a sheet layer peelably laminated on a surface of the adhesive layer.

### CITATION LIST

### Patent Literature

PTL 1: JP2002-85927A
PTL 2: JP2017-15297A

FIG. 3 is a cross-sectional view illustrating a state where a problem that a sheet layer is waved occurs in a filter structure in the related art, and FIG. 4 is a cross-sectional view illustrating a state where a problem that the sheet layer is separated from an adhesive layer during folding occurs in the filter structure in the related art.

In order to attach the filter structure described in PTL 1 or PTL 2 to an object such as a range hood or an intake port of an air conditioner, the sheet layer laminated on the surface of the adhesive layer is peeled off to expose the surface of the adhesive layer, the entire filter structure is aligned with an attachment location on the object while keeping the entire filter structure in an extended state, and then the adhesive layer is stuck to the object.

Incidentally, when a surface state of the adhesive layer in the filter structure deteriorates, there may be a problem that a desired adhesive force cannot be exerted, it is difficult to attach the filter structure to the object, or the filter structure immediately falls off from the object.

With reference to FIG. 3, in a filter structure 30 having a structure in which a filter layer 31, an adhesive layer 32, and a sheet layer 33 are laminated, for example, in a case of adopting a method of once coating the sheet layer 33 with an adhesive, then transferring the adhesive from the sheet layer 33 to the filter layer 31 by overlapping a surface of the sheet layer 33 coated with the adhesive and the filter layer 31, and solidifying the adhesive by drying or the like as appropriate to form the adhesive layer 32 on the filter layer 31, when a thickness of the sheet layer 33 is small, the sheet layer 33 may be waved after the sheet layer 33 is coated with the adhesive or after the adhesive is transferred from the sheet layer 33 to the filter layer 31. Although a reason why the sheet layer 33 is waved is unclear, it is surmised that when an adhesive containing a solvent is used as the adhesive, once the sheet layer 33 is thin, the sheet layer 33 is swollen due to the solvent contained in the adhesive and is in a waved state, or after the adhesive is transferred from the sheet layer 33 to the filter layer 31, when drying is performed in order to volatilize the solvent contained in the adhesive, the sheet layer 33 shrinks or deforms due to heat. Since the adhesive layer 32 formed on the filter layer 31 is also waved due to the waving of the sheet layer 33 and the smoothness of an adhesive surface 32a is reduced, a contact area of the adhesive layer 32 with an object is reduced, and it becomes difficult to exert an appropriate adhesive force.

With reference to FIG. 4, the filter structure 30 is often shipped in a folded and packed state, and since bending strength of the sheet layer 33 is too strong once the thickness of the sheet layer 33 is too large, when the filter structure 30 is folded, there may be a phenomenon in which a portion of the sheet layer 33 corresponding to a bent portion of the filter structure 30 is separated from a surface of the adhesive layer 32. In the filter structure 30, fiber waste and the like are likely to adhere to a location 32b at which the sheet layer 33 is separated in this way and the adhesive layer 32 is exposed until use, and as a result, a state of an adhesive surface deteriorates, and it becomes difficult to exert an appropriate adhesive force to an object during use.

In addition, when the sheet layer 33 having a large surface roughness is used, a surface roughness of the adhesive layer 32 in contact with the sheet layer 33 increases due to the surface roughness of the sheet layer 33, and as a result, the adhesive force of the adhesive layer 32 to the object may be decreased.

It is preferable that the surface roughness of the sheet layer 33 is small to some extent. However, when the surface roughness is too small, that is, when surface smoothness is very high, there is a problem that handling of the sheet layer 33 when manufacturing the filter structure becomes difficult, and a manufacturing cost also increases.

In view of the above problems in the related art, an object of the invention is to provide a filter structure capable of exerting an appropriate adhesive force by an adhesive layer without deteriorating a state of an adhesive surface of the adhesive layer.

### SUMMARY OF INVENTION

In order to achieve the above object, a filter structure according to a first aspect of the invention includes a filter layer having air permeability and configured to filter passing gas, an adhesive layer formed on at least a part of one surface of the filter layer by an adhesive, and a sheet layer laminated on a surface of the adhesive layer and being peelable. The sheet layer has a thickness of 12 μm to 75 μm, and has a surface arithmetic average roughness Ra (arithmetic average roughness Ra according to JIS B0601:2001) of 0.09 μm to 0.4 μm on a surface in contact with the adhesive layer.

With such a configuration, the sheet layer covers and protects the surface of the adhesive layer. When the sheet layer is peeled off, the adhesive layer is exposed, and the filter structure can be used. Since the thickness of the sheet layer is set to 12 μm or more, the sheet layer is less likely to be waved when laminated on the surface of the adhesive layer. Since the thickness of the sheet layer is set to 75 μm or less, the sheet layer easily follows deformation such as bending or folding of the filter structure. Since the surface roughness Ra of the surface of the sheet layer in contact with the adhesive layer is set to 0.09 μm or more and 0.4 μm or less, a surface roughness of the adhesive layer in contact therewith can be controlled.

In a filter structure according to a second aspect of the invention based on the configuration in the invention according to the first aspect, the surface arithmetic average roughness Ra of the sheet layer is 0.1 μm to 0.25 μm.

With such a configuration, the surface roughness Ra of the sheet layer is in a range of 0.1 μm to 0.25 μm, so that surface smoothness of the adhesive layer after the sheet layer is peeled off is improved.

In a filter structure according to a third aspect of the invention based on the configuration in the invention according to the first or second aspect, the thickness of the sheet layer is 12 μm to 25 μm.

With such a configuration, the thickness of the sheet layer is in a range of 12 μm to 25 μm, so that the sheet layer easily follows deformation such as bending or folding of the filter structure.

A filter structure according to a fourth aspect of the invention base on the configuration in the invention according to any one of the first to third aspects is used for at least one of a metal filter or a straightening plate of a range hood, an intake port of an air conditioner, an intake port of an air cleaner, and indoor and outdoor air vents.

With such a configuration, the filter structure is used for at least one of the metal filter or the straightening plate of the range hood, the intake port of the air conditioner, the intake port of the air cleaner, and the indoor and outdoor air vents, and filters the passing gas.

As described above, in the filter structure according to the first aspect of the invention, since the surface of the adhesive layer is protected by the sheet layer, the adhesive layer can be prevented from sticking to objects other than a targeted object before use of the filter structure. In addition, for example, a plurality of filter structures can be overlapped and handleability is improved. By setting the thickness of the sheet layer to 12 μm or more, waving of the sheet layer is reduced, and as a result, the surface smoothness of the adhesive layer is maintained, so that an appropriate adhesive force is exerted when the adhesive layer is stuck to the object. Since the sheet layer can follow deformation such as bending or folding of the filter structure by setting the thickness of the sheet layer to 75 μm or less, even when the filter structure is bent or folded, the sheet layer is less likely to be separated from the adhesive layer. As a result, it becomes difficult to expose the adhesive layer before the use of the filter structure, and a decrease in adhesive force due to adhesion of fiber waste or the like during the use can be prevented. In addition, since the surface roughness Ra of the sheet layer is 0.09 μm or more and 0.4 μm or less, the surface roughness of the adhesive layer in contact with the sheet layer can be controlled to a state of reliably exerting the adhesive force.

In addition to the effect of the invention according to the first aspect, in the filter structure according to the second aspect of the invention, since the surface smoothness of the adhesive layer after the sheet layer is peeled off is improved, an excellent adhesive force can be exerted on the object.

In addition to the effect of the invention according to the first or second aspect, in the filter structure according to the third aspect of the invention, since the sheet layer easily follows deformation such as bending or folding of the filter structure, even when the filter structure is bent or folded, the sheet layer is not separated from the surface of the adhesive layer. Therefore, even in a bent state or a folded state, the sheet layer reliably protects the surface of the adhesive to prevent the decrease in adhesive force due to the adhesion of the fiber waste or the like. Accordingly, since the filter structure can be packaged in a folded state, a product having good handleability can be provided.

In addition to the effect of the invention according to any one of the first to third aspects, in the filter structure according to the fourth aspect of the invention, since the adhesive layer exerts an excellent adhesive force, the filter structure can be reliably attached to any object for use, and there is no risk of falling off over a long period of time.

### BRIEF DESCRIPTION OF DRAWINGS

FIG. 1 is a front view illustrating an example of a filter structure according to an embodiment of the invention.

FIG. 2 is a perspective view illustrating a state where a region S surrounded by a one-dot chain line in the filter structure illustrated in FIG. 1 is enlarged and a part of a sheet layer is peeled off.

FIG. 3 is a cross-sectional view illustrating a state where a problem that a sheet layer is waved occurs in a filter structure in the related art.

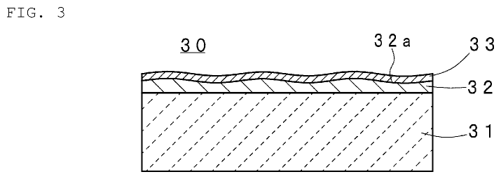

FIG. 4 is a cross-sectional view illustrating a state where a problem that the sheet layer is separated from an adhesive layer during folding occurs in the filter structure in the related art.

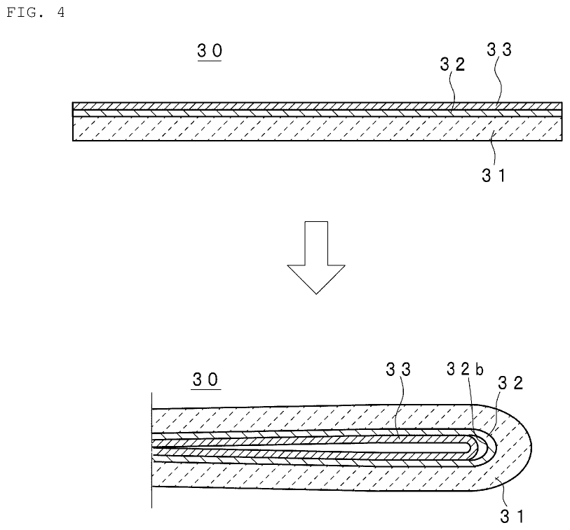

### DESCRIPTION OF EMBODIMENTS

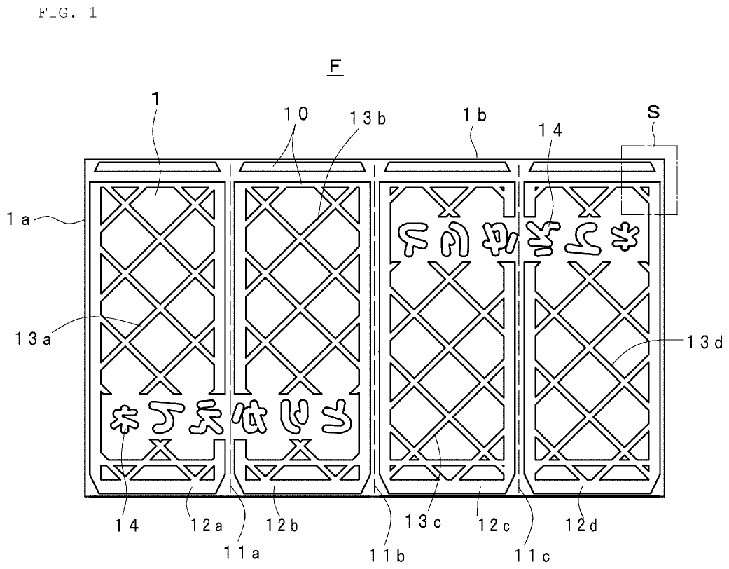

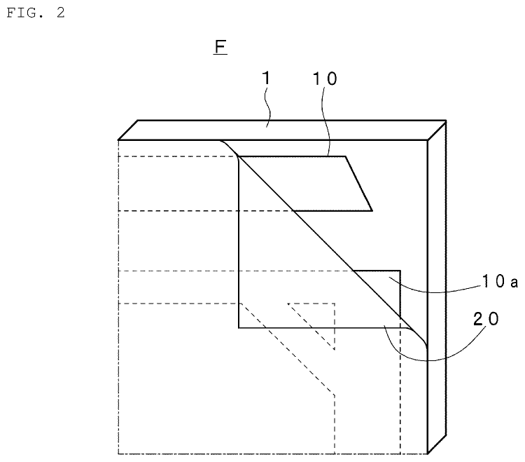

FIG. 1 is a front view illustrating an example of a filter structure according to an embodiment of the invention, and FIG. 2 is a perspective view illustrating a state where a region S surrounded by a one-dot chain line in the filter structure illustrated in FIG. 1 is enlarged and a part of a sheet layer is peeled off.

A filter structure F adheres to an object to filter passing gas, and includes a sheet-shaped filter layer 1 that has air permeability and filters the passing gas, an adhesive layer 10 that is formed on at least a part of one surface of the filter layer 1 by an adhesive and exerts an adhesive force to the object, and a sheet layer 20 that is laminated on a surface of the adhesive layer 10 and is peelable.

### (Filter Layer)

The filter layer 1 is formed of, for example, a nonwoven fabric, a woven fabric, or a knitted fabric, achieves both collection of dust and the like and flow of gas, and has practical strength. It is preferable to use a nonwoven fabric made of a polyester such as polyethylene terephthalate (PET), a polypropylene or a copolymer mainly composed of propylene, or a synthetic resin fiber such as an acrylic fiber containing a modacrylic fiber, but the invention is not limited thereto. A method for manufacturing the nonwoven fabric is not limited, and for example, a nonwoven fabric manufactured by a known method such as a chemical bond method or a thermal bond method can be preferably used. In addition, the filter layer 1 may be subjected to antiviral or antibacterial processing. Further, for a purpose of imparting flame retardancy or the like, an appropriate amount of a fatty acid metal salt such as aluminum stearate can adhere to or a flame-retardant fiber can be mixed with the above synthetic resin fiber. The filter layer 1 preferably has a thickness of 0.3 mm to 15.0 mm and a basis weight in a range of 20 g/m² to 200 g/m². With such a configuration, it is possible to allow the gas to pass through while reliably collecting oil smoke and dust in air, and practical strength can be exhibited. When the thickness is less than 0.3 mm or the basis weight is less than 20 g/m², the practical strength is insufficient and a sufficient collecting function may not be exerted. When the thickness is more than 15.0 mm or the basis weight is more than 200 g/m², flow resistance of the gas increases, which may impair practicality as an air filter.

### (Adhesive Layer)

The adhesive for forming the adhesive layer 10 is not particularly limited, and for example, a two-liquid mixed adhesive containing a main agent and a curing agent, such as a two-liquid mixed polyurethane-based adhesive, or a hot-melt adhesive such as an acrylic hot-melt adhesive, can be used. In addition, the adhesive may be blended with, if necessary, a tackifier for improving adhesion, an additive such as an ultraviolet absorbent, a filler, a colorant, an antioxidant, a defoaming agent, or a light stabilizer, and various additives for preventing a decrease in adhesive force, an adhesive residue, and the like at a low temperature.

As a method of forming the adhesive layer on the filter layer, a known method can be adopted. For example, a method of directly coating the nonwoven fabric with an adhesive, or, as described later, a method of once coating a peelable sheet layer or the like with an adhesive, then bringing the sheet layer into contact with the nonwoven fabric to indirectly coating the nonwoven fabric with the adhesive by a method such as transferring the adhesive to the nonwoven fabric to form an adhesive layer, and then solidifying the adhesive layer by drying, cooling, or the like, can be adopted. The method of directly or indirectly coating the filter layer with the adhesive layer is not limited, and can be performed by, for example, a roller, a spray, a brush, or printing. That is, any of a roll coater method, a comma coater method, a die coater method, an ink jet method, a reverse coater method, a silk screen method, and a gravure coater method using a known device can be adopted. In the case of the indirect coating, for example, a method of printing the adhesive on the peelable release sheet layer coated with silicone with a roll or the like, then bringing an adhesive layer side of the sheet layer into contact with the filter layer and performing pressing with the roll or the like to transfer the adhesive layer to the filter layer, can be adopted.

The filter structure F in the example is used for a range hood, and the adhesive layer 10 is formed in a form that can cope with range hoods having different sizes. Specifically, the filter layer 1 has a rectangular form in which a short side 1a direction is vertical and a long side 1b direction is horizontal, and three perforations 11a to 11c parallel to the short side 1a and substantially equally spaced are formed to penetrate the filter layer and the sheet layer. The adhesive layer 10 includes a first frame portion 12a to a fourth frame portion 12d each formed in a substantially rectangular frame shape in respective one of four regions defined by the perforations 11a to 11c. In addition, grid portions 13a to 13d inclined at about 45° to the short side 1a and the long side 1b are respectively formed inside the first frame portion 12a to the fourth frame portion 12d. Further, a display portion 14 in a character form or the like for displaying a replacement time of a filter is formed on a portion on which a part of the first frame portion 12a to the fourth frame portion 12d and the grid portions 13a to 13d are omitted.

Since the adhesive layer 10 is configured in this way, the filter structure F can have a desired size by cutting the filter layer and the sheet layer by the perforations 11a to 11c selected according to the size of the range hood as a sticking object. In addition, in the example, since the first frame portion 12a to the fourth frame portion 12d are formed in respective one of the regions defined by the perforations 11a to 11c, the cut filter structure F includes the adhesive layer 10 along a contour and can thus be reliably stuck to the object, and a gap between the filter layer 1 and a surface of the object over substantially the entire circumference can be eliminated.

The grid portions 13a to 13d contribute to exertion of the adhesive force of the filter structure F. In particular, when the filter structure F is used for a range hood with a straightening plate, since the grid portions 13a to 13d are to be stuck to the straightening plate, the adhesive force of the filter structure F is improved in addition to an adhesive force of the first frame portion 12a to the fourth frame portion 12d. In addition, by forming the adhesive in a grid shape, an area of closing an intake port of the range hood or the like can be reduced, thereby making it difficult to block the flow of the air.

The display portion 14 is for visually displaying the replacement time of the filter structure F, and may be formed in a picture or graphic form in addition to the illustrated character form. On a portion of the filter layer 1 through which the air flows, coloration progresses due to accumulation of dust or the like, whereas since the flow of the air is reduced on the portion at which the adhesive layer is formed, the coloration of the filter layer 1 does not progress. As a result, as the use is continued, the character or the like on the display portion 14 formed of the adhesive appears white, so that the replacement time of the filter structure F can be displayed. In addition, the display portion 14 also contributes to an adhesion force to the object.

### (Sheet Layer)

The sheet layer 20 is laminated on the surface of the adhesive layer 10 to protect an adhesive surface 10a. By providing the sheet layer 20, the adhesive layer 10 can be prevented from sticking to objects other than a target object before use of the filter structure F. In addition, for example, a plurality of filter structures can be overlapped and handleability is improved. In use, as illustrated in FIG. 2, it is sufficient that the sheet layer 20 is peeled off from the adhesive layer 10 and the exposed adhesive surface 10a is stuck to the object like a seal.

A material of the sheet layer 20 is not particularly limited as long as conditions for a thickness and a surface roughness described later can be satisfied. For example, a PET film or the like on which a silicone coat is formed on at least one surface is used. In addition, cellophane or a resin film other than PET can be used. Further, as long as the conditions for the thickness and the surface roughness described later are satisfied, paper, a metal sheet, or the like subjected to surface processing such as resin coating can also be used.

The thickness of the sheet layer in the example is preferably in a range of 12 μm to 75 μm, and more preferably in a range of 12 μm to 25 μm. In addition, a surface arithmetic average roughness (arithmetic average roughness according to JIS B0601:2001, hereinafter referred to as “surface roughness”) Ra of the sheet layer is preferably in a range of 0.09 μm to 0.4 μm, and more preferably in a range of 0.1 μm to 0.25 μm. The thickness of the sheet layer can be measured by a micrometer method (JIS C2151).

When the thickness of the sheet layer is 12 μm or more, waving of the sheet layer laminated on the surface of the adhesive layer of the filter structure can be reduced, and as a result, surface smoothness of the adhesive layer is maintained, so that the filter structure can adhere to the object and an appropriate adhesive force can be exerted. When the thickness of the sheet layer is less than 12 μm, the waving is likely to occur, and as a result, the surface smoothness of the adhesive layer may deteriorate.

When the thickness of the sheet layer is 75 μm or less, the sheet layer can follow deformation such as bending or folding of the filter structure, so that even when the filter structure is bent or folded, the sheet layer is less likely to be separated from the adhesive layer. As a result, it becomes difficult to expose the adhesive layer before the use of the filter structure, and a decrease in adhesive force due to adhesion of fiber waste or the like during the use can be prevented. When the thickness of the sheet layer is more than 75 μm, bending strength of the sheet layer is too large, so that when the filter structure is folded, there may be a phenomenon in which a portion of the sheet layer corresponding to a bent portion of the filter structure is separated from the surface of the adhesive layer. In the filter structure, fiber waste and the like are likely to adhere to a location at which the sheet layer is separated in this way and the adhesive layer is exposed until use, and as a result, a state of the adhesive surface deteriorates, and it becomes difficult to exert an appropriate adhesive force to the object during the use.

When the surface roughness Ra of the sheet layer is 0.09 μm or more and 0.4 μm or less, a surface roughness of the adhesive layer in contact with the sheet layer can be controlled to a state of reliably exerting the adhesive force, so that the adhesion to the object is improved.

When the surface roughness Ra of the sheet layer is more than 0.4 μm, the surface roughness of the adhesive layer in contact with the sheet layer also increases, so that a contact area with the object is reduced, and as a result, the adhesive force may not be sufficiently exerted.

When the surface roughness of the sheet layer is less than 0.09 μm, the surface smoothness of the sheet layer is very high, so that the handleability of the sheet layer when manufacturing the filter structure deteriorates. In addition, a manufacturing cost may increase.

The surface roughness Ra of the sheet layer is more preferably in a range of 0.1 μm to 0.25 μm. When the surface roughness Ra is set in this range, the surface smoothness of the adhesive layer after the sheet layer is peeled off is increased, so that a more excellent adhesive force can be exerted to the object, and in particular, a decrease in adhesive force over time under a high temperature condition can be prevented.

The thickness of the sheet layer is more preferably in a range of 12 μm to 25 μm. By setting the thickness in this range, the sheet layer easily follows deformation such as bending or folding of the filter structure, the sheet layer can follow deformation of the filter layer and the adhesive layer even when the filter structure is bent or folded, so that the sheet layer is further less likely to be separated from the adhesive layer. Therefore, even in a bent state or a folded state, the sheet layer reliably protects the surface of the adhesive layer to prevent the decrease in adhesive force of the adhesive surface due to the fiber waste or the like. As a result, the filter structure can be packaged in a folded state, so that a product having good handleability can be provided.

In the filter structure in the example configured as described above, when the sheet layer is peeled off, the surface smoothness of the exposed adhesive layer is maintained and good smoothness is achieved, so that the adhesion when the filter structure is pressed to the object is improved, and an appropriate adhesive force can be exerted. Moreover, compared with a product in the related art, the handleability may not be reduced, or a particular increase in cost may not occur.

The filter structure in the example can be used for, for example, an outside of a range hood in a kitchen or a galley, an intake port of an air conditioner or an air cleaner, a household or business equipment such as an extractor fan, an air vent installed indoors and outdoors, or the like.

It is necessary to cut a part of the filter structure according to a form of the object for use. For example, when the filter structure is used for a front intake type air cleaner, since a support that supports a front cover of the air cleaner may interfere with the filter structure, a portion including four corners of the rectangular filter layer is set as a planned resection region. In order to cope with the above, at least one of the filter layer and the sheet layer may be provided with a display indicating the planned resection region of the filter layer by printing or the like. Alternatively, perforations along the planned resection region of the filter layer may be formed. Further, the adhesive layer may be formed so as to display the planned resection region of the filter layer. The planned resection region is not limited to the corner, and a location corresponding to a portion interfering with an attachment object when the filter structure is attached may be set as the planned resection region. For example, in a case of a circular filter structure, since there is no angle, there is no corner, and a location corresponding to a portion interfering with the attachment object may be set as the planned resection region. Further, the planned resection region may not be set.

In the above embodiment, the shape of the filter structure is a rectangular shape, but the shape is not limited thereto, and various shapes such as polygonal, circular, and elliptical shapes can be adopted.

In the above embodiment, the display portion for displaying the replacement time of the filter is formed, but the display portion may not be formed. In addition to the character, a picture, a symbol, a graphic, and the like may be formed as the display portion. The number of the character, the picture, the symbols, the graphic, and the like may be one or more.

Further, in the above embodiment, the adhesive layer includes those obtained by pattern-printing a strip-shaped adhesive in a frame-shaped or grid-shaped form, but as an adhesive layer containing no strip-shaped adhesive layer, an adhesive layer having a configuration obtained by scattering the applied adhesive by spraying over the entire surface of the filter layer may be formed.

### EXAMPLES

Filter structures in Examples 1 to 8 and Comparative Examples 1 to 11 each including a sheet-shaped filter layer, an adhesive layer 10 formed on a part of one surface of the filter layer, and a sheet layer 20 laminated on a surface of the adhesive layer 10 and being peelable were prepared by a method of using a sheet layer having a material, a thickness, and a surface roughness described in Table 1, once coating the sheet layer with an adhesive, then transferring the adhesive from the sheet layer to the filter layer by overlapping a surface of the adhesive coated with the sheet layer and the filter layer, and solidifying the adhesive to form an adhesive layer on a filter layer. The filter layer used in each of the filter structures in Examples and Comparative Examples was mainly formed of a nonwoven fabric made of a PET fiber, and a basis weight thereof was 40 g/m². In addition, a coating amount on the adhesive layer formed on each of the filter structures in Examples and Comparative Examples was 30 g/m². The following tests were performed using these filter structures.

### (1) Presence or Absence of Waving

In a state where the sheet layer is laminated on the surface of the adhesive layer formed on the one surface of the filter layer, presence or absence of waving of the sheet layer was determined based on the following evaluation criteria for the filter structures in Examples and Comparative Examples using the respective sheet layers illustrated in Table 1.
B (or A): no waving.
C (or B): slight waving.
D: there is clearly large waving, and bagginess is observed in the sheet layer.

### (2) Sticking Suitability (Uneven Surface)

In the adhesive layer exposed by peeling off the sheet layer, one obtained by cutting each of the filter structures in Examples and Comparative Examples into a size of 4 cm×11 cm was stuck to an ABS resin plate subjected to emboss processing on a surface thereof, placed vertically, and presence or absence of falling off was checked. The sticking was performed by a method of reciprocating once at a pressure of 2 kg/cm² by a roller. Presence or absence of filter falling off was examined on the obtained sample. The determination was performed based on the following evaluation criteria.
B: stuck.
D: peeled off.

The test evaluates adhesion to a surface that is uneven to some extent.

### (3) Sticking Suitability (Range Hood)

In the adhesive layer exposed by peeling off the sheet layer, each of the filter structures in Examples and Comparative Examples cut in substantially the same size as a metal filter of a range hood subjected to fluorine processing on a surface thereof was stuck to the metal filter by a method of reciprocating once at a pressure of 2 kg/cm² by a roller, then a surface to which the filter structure was stuck was left at room temperature for one week in a state of facing downward, and whether the filter structure remained a stuck state or was peeled off was observed. The determination was performed based on the following evaluation criteria.
B: being stuck.
D: peeled off.

### (4) Sticking Suitability Over Time (Under High Humidity Condition)

In a state where half of the sheet layer of the filter structure was peeled off and exposed, and sticking was performed on an acrylic plate, followed by leaving in this state in an environment with a temperature of 25° C. and a humidity of 95%. After 24 hours, when the acrylic plate was shaken up and down 10 times, whether the filter structure remained a stuck state or was peeled off was observed. This test evaluates presence or absence of deterioration of the adhesive. The determination was performed based on the following evaluation criteria.
A: not peeled off.
B: slightly peeled off.
D: half or more peeled off.

### (5) Bending Processing Suitability

When each of the filter structures in Examples and Comparative Examples was cut into 61 cm×36 cm, folded into two, and then again expanded to an original state before bending, whether the bent portion has a portion on which the sheet layer is floated from the adhesive layer was observed. The test evaluates followability of the sheet layer.
A: when the filter structure was bent and then expanded again, the sheet layer was not floated from the adhesive surface at all.
B: slight but partly floated.
D: the sheet layer on the bent portion was completely floated.

### (Surface Roughness Measurement)

The surface roughness Ra (arithmetic average roughness Ra according to JIS B0601:2001) of the sheet layer of each of the filter structures used in the tests was measured using a CNC surface shape measuring machine “CS-H5000CNC” manufactured by Mitutoyo Corporation. Evaluation conditions are as follows.

$$Evaluation Conditions : curved line = R\_J01 - location = [ 1 ]$$

Standard: JIS B0601:2001
Evaluation curved line type: R_J01
Reference length: 0.8 mm
Number of sections: 5
λc: 0.8 mm
λs: 0.0025 mm
Filter type: Gaussian
Evaluation length: 4.0 mm
Run-up: 0.4 mm
Back run: 0.397 mm
Smoothness connection: Off
Test results are illustrated in Table 1.

TABLE 1

| | | | | | | | Test (4) | |
|---|---|---|---|---|---|---|---|---|
| | Sheet layer | | | | | | Sticking | |
| | | | Surface | Test (1) | Test (2) | Test (3) | suitability over | Test (5) |
| | Material | | roughness | presence or | Sticking | Sticking | time (under | Bending |
| | PET | Thickness | (Ra) | absence of | suitability | suitability | high humidity | processing |
| | film/paper | (μm) | (μm) | waving | (uneven surface) | (range hood) | condition) | suitability |
| Example 1 | Film | 12 | 0.0900 | B | B | B | A | A |
| Example 2 | Film | 12 | 0.1062 | B | B | B | A | A |
| Example 3 | Film | 12 | 0.4000 | B | B | B | B | A |
| Example 4 | Film | 15 | 0.1305 | B | B | B | A | A |
| Example 5 | Film | 25 | 0.1632 | B | B | B | A | A |
| Example 6 | Film | 38 | 0.1761 | B | B | B | A | B |
| Example 7 | Film | 50 | 0.2310 | B | B | B | A | B |
| Example 8 | Film | 75 | 0.3660 | B | B | B | B | B |
| Comparative | Film | 2 | 0.1098 | D | D | D | D | A |
| Example 1 | | | | | | | | |
| Comparative | Film | 4 | 0.1154 | D | D | D | D | A |
| Example 2 | | | | | | | | |
| Comparative | Film | 5 | 0.1239 | D | D | D | D | A |
| Example 3 | | | | | | | | |
| Comparative | Film | 6 | 0.1531 | D | D | D | D | A |
| Example 4 | | | | | | | | |
| Comparative | Film | 100 | 0.1740 | B | B | B | A | D |
| Example 5 | | | | | | | | |
| Comparative | Film | 125 | 0.1744 | B | B | B | A | D |
| Example 6 | | | | | | | | |
| Comparative | Film | 150 | 0.1888 | B | B | B | A | D |
| Example 7 | | | | | | | | |
| Comparative | Paper | 80 | 0.5985 | B | D | D | D | D |
| Example 8 | | | | | | | | |
| Comparative | Paper | 90 | 0.8627 | B | D | D | D | D |
| Example 9 | | | | | | | | |
| Comparative | Paper | 100 | 0.9273 | B | D | D | D | D |
| Example 10 | | | | | | | | |
| Comparative | Paper | 160 | 1.2134 | B | D | D | D | D |
| Example 11 | | | | | | | | |

From the results illustrated in Table 1, the product according to the invention exhibits a good result in any of the tests (1) to (5) when the thickness of the sheet layer is in a range of 12 μm to 75 μm and the surface roughness Ra is in a range of 0.09 μm to 0.4 μm.

In particular, when the surface roughness Ra of the sheet layer is in a range of 0.09 μm to 0.25 μm (Examples 1, 2, and 4 to 7), the sticking suitability over time (under high humidity condition) in the test (4) is excellent.

In addition, it can be seen that when the thickness of the sheet layer is in a range of 12 μm to 25 μm (Examples 1 to 5), the bending processing suitability is excellent.

On the other hand, it can be seen that even when the sheet layer is a PET film, when the thickness is too small, even if the surface roughness Ra is suitable, waving occurs, and as a result, an appropriate adhesive force cannot be exerted. On the contrary, it can be seen that when the sheet layer is too thick, even if the surface roughness Ra is suitable, the folding processing suitability is poor.

Further, it can be seen that the thickness and the surface roughness of each of the sheet layers made of paper used in Comparative Examples 8 to 11 are not within the ranges in the invention, so that an appropriate adhesive force and folding suitability cannot be exerted.

### INDUSTRIAL APPLICABILITY

The invention can be applied to a filter structure product used for a range hood in a kitchen or a galley, an intake port of an air conditioner or an air cleaner, a household or business equipment such as an extractor fan, and an air vent installed indoors and outdoors. In particular, application to a filter structure bent or folded is preferable. In addition, according to the invention, a filter structure product in which a part thereof can be resected or cut according to a form of an attachment object can be provided. Alternatively, a filter structure product having various shapes such as rectangle, polygonal, circular, and elliptical shapes can be provided. Further, a filter structure product including a display portion for displaying a replacement time of a filter can be provided.

1. A filter structure (F) comprising:
a filter layer (1) having air permeability and configured to filter passing gas;
an adhesive layer (10) formed on at least a part of one surface of the filter layer by an adhesive; and
a sheet layer (20) laminated on a surface of the adhesive layer and being peelable, wherein
the sheet layer has a thickness of 12 μm to 75 μm, and has a surface arithmetic average roughness Ra (arithmetic average roughness Ra according to JIS B0601:2001) of 0.09 μm to 0.4 μm on a surface in contact with the adhesive layer.

2. The filter structure according to claim 1, wherein
the surface arithmetic average roughness Ra of the sheet layer is 0.1 μm to 0.25 μm.

3. The filter structure according to claim 1, wherein
the thickness of the sheet layer is 12 μm to 25 μm.

4. The filter structure according to claim 1, which is used for at least one of a metal filter or a straightening plate of a range hood, an intake port of an air conditioner, an intake port of an air cleaner, and indoor and outdoor air vents.
